(19) United States
(12) Patent Application Publication
(10) Pub. No.: US 2017/0095036 A1
(43) Pub. Date: Apr. 6, 2017

(54) FOOTWEAR HAVING POLYURETHANE BRIDGE LAYER JOINING SOLE AND UPPER AND METHOD OF MANUFACTURING SAME

(71) Applicant: Maoshuang Chen, Fuzhou City (CN)

(72) Inventor: Maoshuang Chen, Fuzhou City (CN)

(21) Appl. No.: 14/943,544

(22) Filed: Nov. 17, 2015

(30) Foreign Application Priority Data
Oct. 6, 2015 (CA) 2,906,693

(51) Int. Cl. A43B 13/28; A43B 13/04; A43B 13/12; B29D 35/00

(52) U.S. Cl. CPC A43B 13/28; B29D 35/0009; A43B 13/04; A43B 13/125

(57) ABSTRACT

The present invention is generally related to an article of footwear, in particular, to an improved article of footwear that has a polyurethane bridge layer joining sole and upper, without having to use glue or some other bonding agent and a method of manufacturing such an article of footwear.

### FIELD OF INVENTION

The invention relates generally to the field of footwear. In particular, the invention relates to an article of footwear having polyurethane (“PU”) bridge layer joining sole and upper and method of manufacturing same.

### BACKGROUND OF INVENTION

A shoe has an upper and a sole. To make a shoe, the upper is to be attached to the sole. Attaching the upper to the sole can be a labor-intensive process. For example, one of the traditional methods of attaching an upper to a sole is to glue an upper to a sole. It will be necessary for a worker to apply primer and then glue to the upper and/or the sole first, and then press the upper against the sole to firmly glue them together. Uniform and appropriate application of glue may require considerable skill. Consistent application of glue is also required. Finished shoes may not appear clean if over-glued. Of course, any under-glue may cause serious quality, in particular, durability, concerns.

There have been proposals of forming a midsole from mould injected PU material, which tends to bond well with both leather, often used as upper material, and rubber, a frequent choice for sole material. However, PU material is relatively heavy. PU injected shoes therefore tend to be heavy and thus disfavored by consumers.

Thus, there is a need for an improved method of attaching upper to sole that is less labor-intensive and less dependent on worker's skill level, and a need for an improved shoe that is durable, comfortable to wear and less heavy as compared to the existing art. It is an object of the present invention to mitigate or obviate at least one of the above mentioned disadvantages.

### SUMMARY OF INVENTION

The present invention is generally related to an article of footwear, in particular, to an improved article of footwear that has a polyurethane bridge layer joining sole and upper, without having to use glue or some other bonding agent and a method of manufacturing such an article of footwear.

In a first aspect of the invention, a method of making an article of footwear is provided. The article of footwear has an upper and a sole. The method includes the steps of: placing a pre-constructed sole in a first half of a mould, placing a pre-constructed upper in a second half of a mould, the pre-constructed upper being mounted to a last when placed in the second half, closing the first half and the second half to bring them together, the closed mould having a gap between the sole and the last, injecting a bonding material into the gap and allowing the injected bonding material to solidify to form an injected bonding layer to join the upper to the sole, and removing the bonded article of footwear from the mould and the last.

In a second aspect, there is provided an improved article of footwear. The article of footwear has an upper, a sole, the sole comprising a midsole made of EVA disposed on top and securely attached to a outsole, and a bridge layer of injected polyurethane (“PU”) material joining the midsole to the upper. The article of footwear may further include an insole fabric attached to the upper, such that the injected polyurethane material formed bridge layer also joins the insole fabric to the midsole.

In other aspects the invention provides various combinations and subsets of the aspects described above.

### BRIEF DESCRIPTION OF DRAWINGS

For the purposes of description, but not of limitation, the foregoing and other aspects of the invention are explained in greater detail with reference to the accompanying drawings, in which:

FIG. 1 is an exploded perspective view of an article of footwear that has a polyurethane bridge layer joining sole and upper;

FIG. 2A and FIG. 2B are cross-sectional views illustrating making a sole assembly in a mould for the article of footwear shown in FIG. 1;

FIG. 3 is a top view of a sole assembly illustrating a peripheral loop along which the upper is joined to the sole;

FIG. 4A and FIG. 4B are cross-sectional views illustrating a process of joining an upper to a sole assembly shown in FIG. 2 to produce the article of footwear shown in FIG. 1, in which FIG. 4A shows the mould in an open position and FIG. 4B shows the mould in a closed position;

FIG. 5 illustrates in a sectional view the article of footwear made according to the process shown in FIG. 4A and FIG. 4B;

FIG. 6 is a lateral side view showing an article of footwear made according to the process shown in FIG. 4A and FIG. 4B and a decorative band formed from the injected polyurethane; and

FIG. 7 is a flow chart illustrating a method for making an article of footwear shown in FIG. 6.

### DETAILED DESCRIPTION OF EMBODIMENTS

The description which follows and the embodiments described therein are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

The present invention relates to an article of footwear, in particular, to an improved article of footwear that has a polyurethane bridge layer joining sole and upper, without having to use glue or some other bonding agent and a method of manufacturing such an article of footwear.

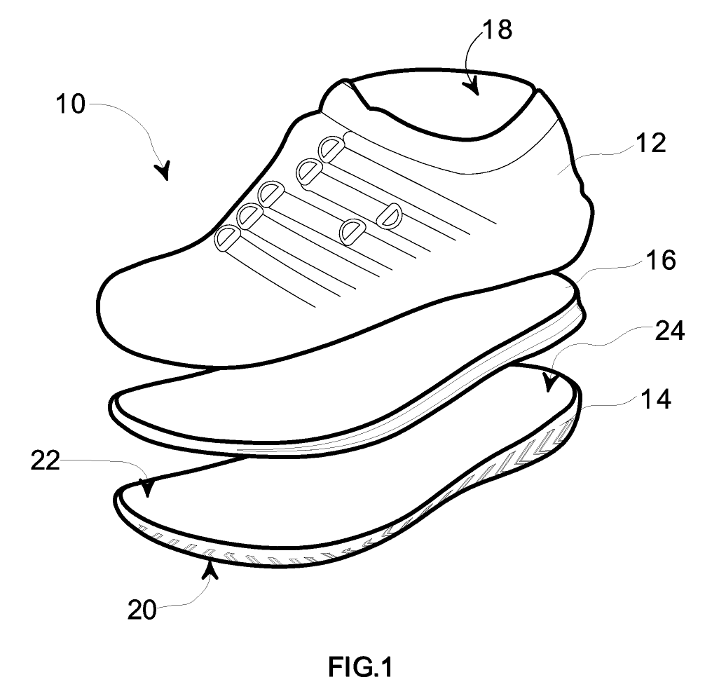

Referring to FIG. 1, an article of footwear, or shoe 10, which may be a casual shoe, a running shoe, a crossing-training shoe, a high-top shoe, a boot, a snow boot, an adult shoe, an infant shoe, among others, has an upper 12 joined to a sole assembly 14, or sole, by a bonding layer 16.

Upper 12 may be made of a flexible material, such as leather (synthetic or natural), canvas, nylon, among others, which provides covering and protection for foot received therein. The protective, flexible material shields the foot from environment. Such protective, flexible materials often are selected from durable, strong materials, which may cause discomfort when making direct contact with a wearer's foot. An upper may include a layer or layers, made of softer more cushioning material or materials, or lining 18, to provide comfort to the wearer. Upper 12 also helps position the foot relative to the sole assembly. As is well known, upper 12 may cover the entire foot, a major portion of a foot, or only a necessary portion so that the foot may be adequately positioned relative to the sole.

Sole 14 provides a contacting surface 20 against ground, to provide traction and weight support. Often, an abrasion-resistant material, such as rubber, is selected for a sole. For comfort, it is desirable that sole also provides impact attenuation, or cushioning, which would demand a softer material, such as ethyl vinyl acetate (“EVA”). EVA, which may include molded EVA, compression EVA, phylon EVA, compression molded EVA (CM EVA), among others, is lighter than rubber, and therefore also helps reduce sole weight and therefore overall weight of a shoe, which is generally preferred. Upper surface 22 of sole 14 provides a bonding surface, so that the bonding layer 16 can bond with sole 14, at the bonding surface 24, to securely join sole 14 to upper 12. In one embodiment, bonding layer 16 is an injection formed PU layer, which bonds well with EVA which forms the bonding surface 24.

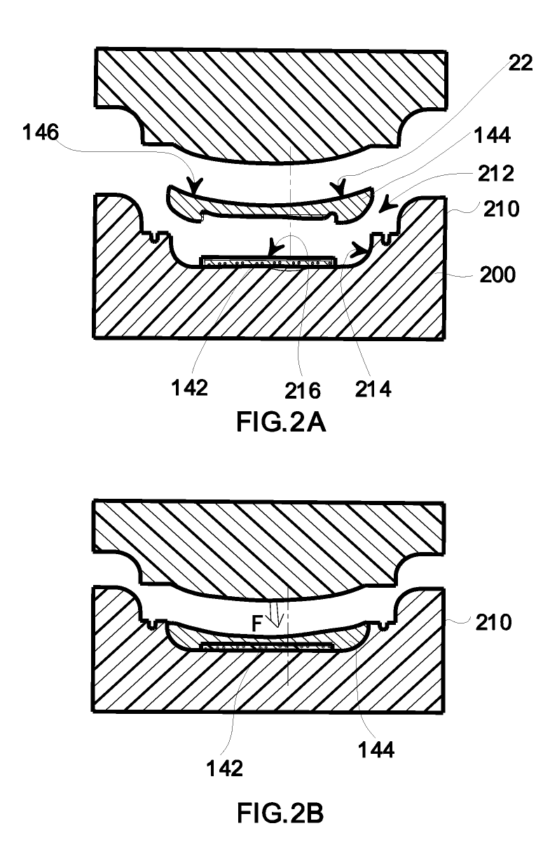

Conveniently, sole 14 may have a multi-layer structure, each layer being formed from a material selected to meet one or more requirements for a sole assembly, so that the assembled sole structure can meet the diverse, and at times, opposite requirements. Referring to FIG. 2A, one such multi-layer sole assembly 14 has an outsole 142 that provides the abrasion-resistant contacting surface 20, and a midsole 144 disposed on top of and attached to outsole 142 to provide cushioning function. Outsole 142 may be made of rubber, EVA or any other suitable materials. Midsole 144 may be made of EVA, so that its upper surface 22 provides the desired bonding property for bonding with a PU layer. Midsole 144 may be securely attached to outsole 142 by glue, suitable bonding agent, stitching, or any other suitable means.

FIG. 2A and FIG. 2B show an example of attaching midsole 144 to outsole 142 by glue. To securely glue midsole 144 to outsole 142, one first places outsole 142 in a mould (or lower half 210 of a mould 200). The lower half 210 has a hollow space 212 to receive the outsole 142 and/or midsole 144, or more generally, sole 14. The bottom surface 214 of the hollow space is formed to generally conform with the shape of the bottom portion of the outsole or midsole (or the sole in general), so that against the bottom surface 214, the outsole 142 (or sole 14) can be firmly seated. After a layer or line of glue 216 is applied to both or either one of the contacting surfaces of the midsole and the outsole, the midsole is placed on top of the outsole and a compression force F is applied (by the top half of the mould, for example) to the midsole toward outsole to firmly glue the midsole to the outsole (see FIG. 2B). The sole assembly 14 so constructed is ready to be joined to upper 12.

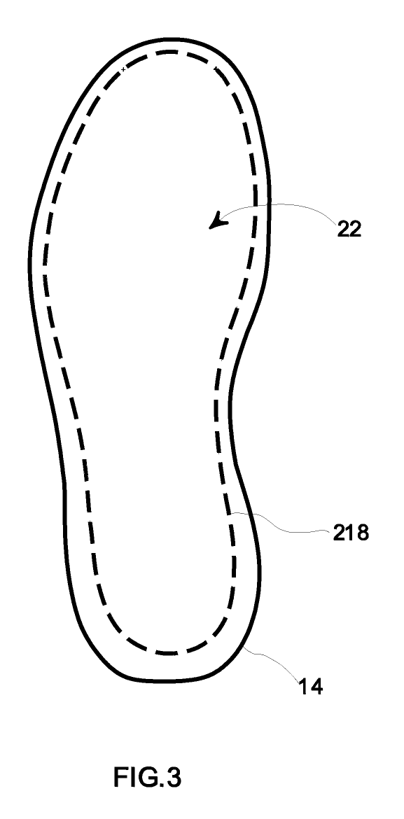

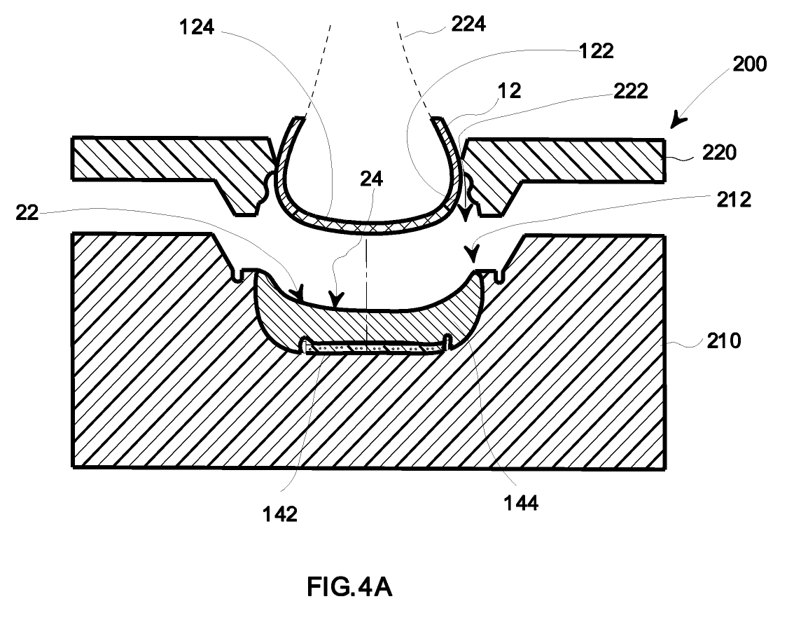

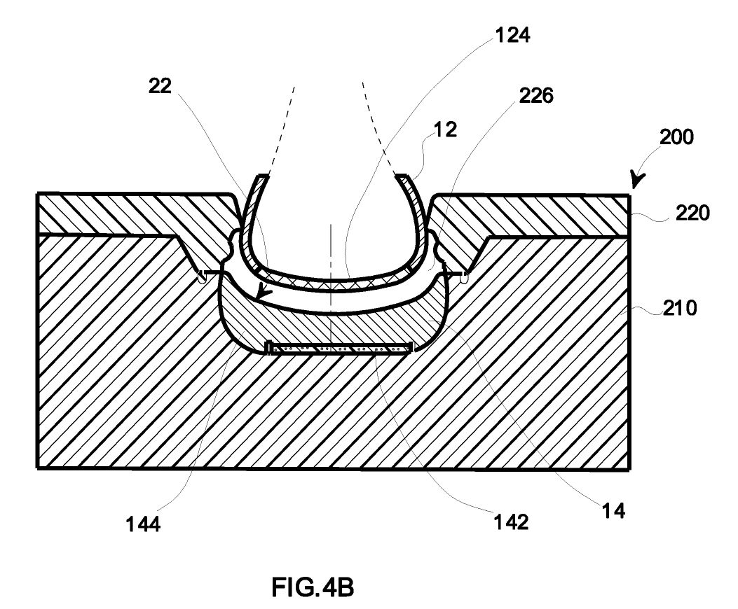

Upper 12 may be joined directly to sole 14 by bonding layer 16 at the upper's bottom edge 122, along a peripheral line (e.g., when upper is constructed to cover only portion(s) of a foot) or a peripheral loop 218 on the sole 14, such as on its upper surface 22 (see FIG. 3). Alternatively or additionally, a layer of insole fabric 124 is first securely attached to upper 12 and the bonding layer joins the insole fabric, and hence the upper, to the sole 14. This can be better seen in FIG. 4A or FIG. 4B.

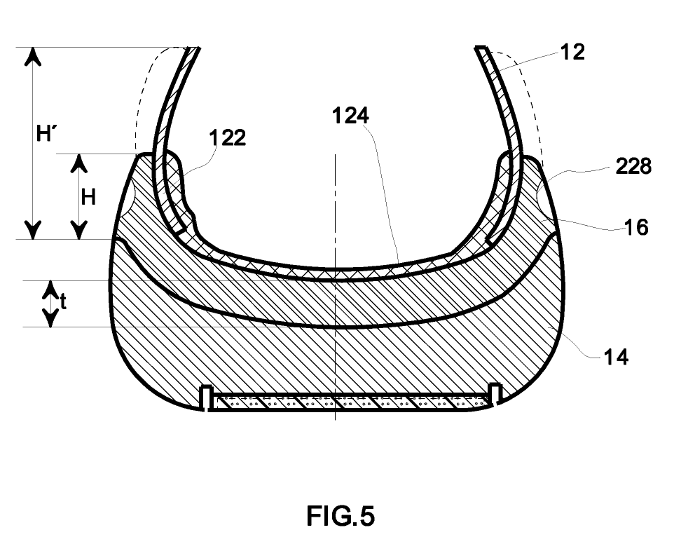

Referring to FIG. 4A, there is shown an upper 12, having an insole fabric layer 124 attached thereon, for example, by stitching. The insole fabric 124 may terminate and be stitched to upper 12 near its bottom edge 122, or, the insole fabric may be part of the upper's lining 18 and extend to cover a portion of or the entire interior of the upper 12 as illustrated in FIG. 5, or, the insole fabric 124 may overlap with only part of the upper's interior. Although it is shown in FIG. 4A that the insole fabric is attached to the interior of upper, it is also possible that the insole fabric be attached to the exterior of upper 12.

To maintain upper 12 in a desired shape when joining an upper to a sole, and to properly position the upper relative to the sole, the upper 12 is placed in a mould, or an upper half 220 of a mould 200, as illustrated in FIG. 4A and FIG. 4B. The upper half 220 of the mould has a second hollow space 222, that is formed to generally conform with a desired shape of a shoe 10. A last 224, which has a shape generally complementing that of the second hollow space 222, is placed inside the upper 12, to maintain the upper's shape, in cooperation with the second hollow space 222. The bottom surface of the last 224 is generally formed to be conforming with the upper surface 22 (or bonding surface 24) of the sole 14, or the upper surface of the EVA midsole, so that the bonding layer formed, in a process to be described, will have a generally uniform thickness. Of course, it will be understood that the bottom surface of the last 224 may not necessarily conform with the upper surface, or bonding surface 24, of the sole. This may be desirable, for example, when non-uniform thickness of the bonding layer 16 is desired. As will be appreciated by one skilled in the art, with suitable selection of bonding material for the bonding layer, such as PU, the bonding layer may replace a sock liner. It thus may be desirable to have a sock liner of varying thickness and the shape of the bottom surface of the last may be conveniently designed for producing a PU layer of varying thickness. Another example of a PU injection layer that has a flared peripheral edge, that is, increased thickness toward the peripheral edge, for forming a decorative ring will also be described later.

When the upper half 220 and the lower half 210 of the mould 200 are brought together, i.e., closed, for example, by lowering the upper half 220 toward the lower half 210 (see FIG. 4B), the first hollow space 212 and the second hollow space 222 together form a cavity that generally conforms to the shape of the shoe 10, including that of the peripheral edge of the bonding layer. FIG. 4B shows the mould in a closed position. As can be seen in FIG. 4B, when these two halves are brought together, there is a gap 226 between the insole fabric 124 and the upper surface 22 of the midsole, or the bonding surface 24. This gap defines the thickness of the bonding layer, which may be uniform or varying across the bonding surface.

In one embodiment, the bonding material is selected to be PU, which has good bonding property with EVA, leather and fabric. The PU bonding layer may be formed by injection. For satisfactory bonding result, the PU material is injected at a temperature of about 63° C., so that it can maintain good fluidity before solidified. Maintaining good fluidity, or appropriate viscosity, is advantageous because it helps apply the injected PU material across the entire bonding surface, not concentrating around injection sites. Optimally, it is found that the temperature of injected PU should be maintained at 62.6° C., though when the temperature is in the range of 55° C. to 65° C., satisfactory results can be obtained. For general bonding purposes, the thickness of the injection formed PU layer, or PU injection layer, may be in the range of 2 mm to 5 mm, though it may also be thicker if desirable.

Referring to FIG. 4A, FIG. 4B and FIG. 5, the thickness of the gap 226, or the thickness of the resulting PU layer 16, may be conveniently maintained by appropriately selecting a depth of the first hallowed space 212 and further adjusted by appropriate positioning of the last 224 relative to the mould during injection, or the gap may be maintained using any other suitable means. To allow the injected PU material to cure properly so that the solidified PU layer can securely join the upper to the sole, exposure of injected PU material to the air is to be avoided or at least reduced. This may be achieved by bringing the two halves of the mould together, so that the gap between the insole fabric and the bonding surface is essentially a sealed enclosure or space (see FIG. 4B), to avoid or reduce exposure of injected PU to air.

After the injected PU cools down, e.g., naturally in room temperature environment, and solidifies to form a solid PU layer, the manufactured shoe may be taken out of the mould and removed from the last. Any necessary trimming or shaping may also be carried out to provide a more attractive product.

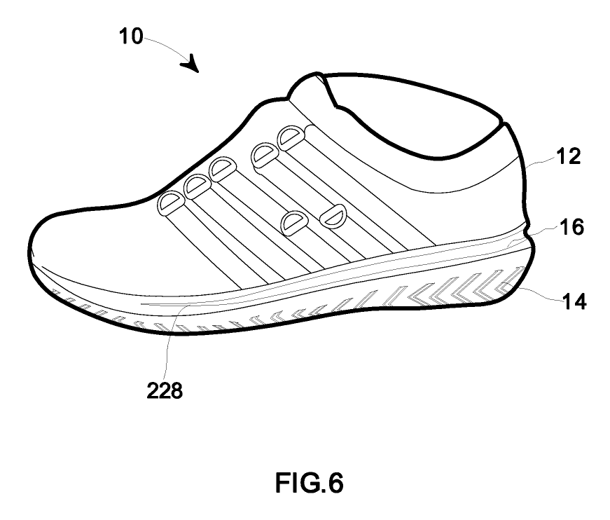

Referring to FIG. 5 and FIG. 6, the injection formed PU layer 16 has a peripheral edge 228 along the peripheral line or loop 218 on top of the sole where the upper 12 is joined to sole 14. The peripheral edge is flared (as can be more clearly seen in FIG. 5), i.e., the thickness of the bonding layer increases outwardly, such that the peripheral edge 228 takes the form of a protective belt or ring, to protect the bottom edge of the upper from being exposed. Such a protective belt or ring may be particularly desirable for certain types of footwear, such as snow boot, generally exposed to harsher environment. For example, the peripheral edge 228 may have a height larger for a snow boot than that for a regular type of footwear, such as a running shoe, and may extend upward toward along the exterior surface of the upper 12 to protect the bottom edge 122 and region adjacent the bottom edge (sandwiched between the peripheral edge and the portion of insole fabric attached to the interior of upper), as shown in FIG. 5 and FIG. 6. Thus, the height of the peripheral edge 228 may need to be appropriately selected for adequate protection of the bottom edge 122 and region adjacent the bottom edge. As an example, the peripheral edge 228, or protective belt or ring, may have a height H of 5 mm or more, such as between 5 mm and 10 mm, or over 10 mm if the shoe design so requires, or at a height H′ up to 100 mm for a snow boot (peripheral edge indicated in dashed lines in FIG. 5) as required by the design. Alternatively, the ratio of the height H of the protective belt or ring and the thickness t of the PU layer (measured by general thickness near or around the middle of the sole) may be 3:1 or even 20:1 or higher, though often a ratio of 5:1 tends to be suitable, for footwear that require a protective belt or ring. With addition of color pigment of desired color (or colors), such peripheral belt or ring also provides a decorative belt or ring 228. Because coloring of the decorative ring is not achieved by painting, the color tends to be long lasting and the color ring also tends to have a smoother surface.

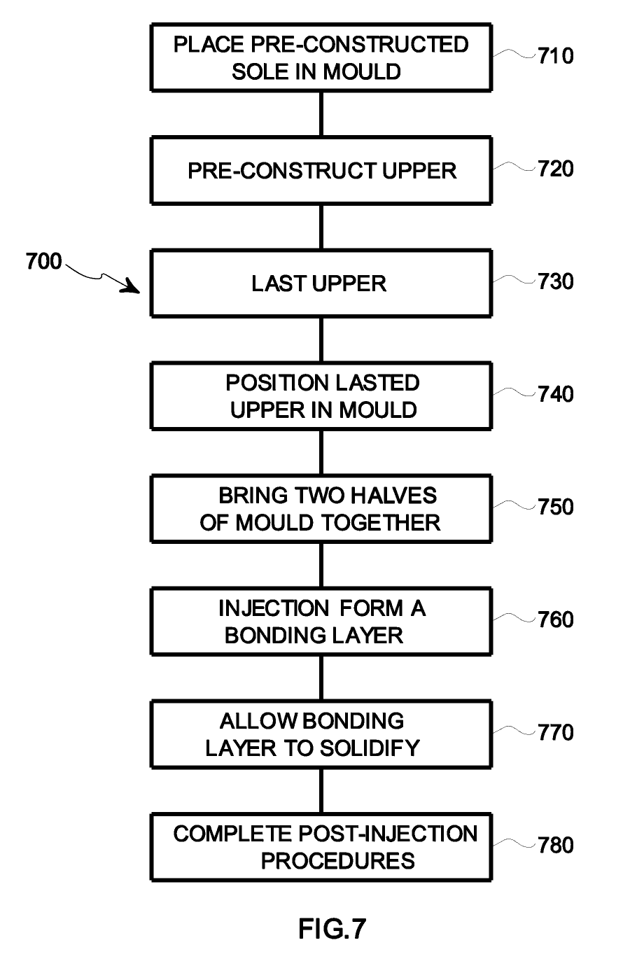

The process of making the shoe 10 described herein may be summarized in reference to a flow chart shown in FIG. 7. To begin, a sole assembly is pre-constructed and placed in the mould (710). An outsole 142, such as rubber outsole, an EVA outsole, PU outsole, or an outsole made of any suitable material, is glued, attached or otherwise secured to with a midsole 144, which may be made of EVA, to form a sole assembly 14. Often, the sole assembly may be pre-constructed elsewhere. The pre-constructed sole assembly is placed in a first half, for example, the lower half 210 of the mould.

Next, an upper 12 is formed, which may be by any traditional means (720). The upper may be formed or pre-constructed with an insole fabric 124 attached thereto, so that when the insole fabric is bonded to sole directly, the upper is attached to the sole, by the attached insole fabric. The formed upper is also lasted (730) or mounted to a last 224, with the bottom surface of the last 224 placed against the insole fabric 124. The formed and lasted upper is disposed in a first half, for example, the upper half 220 of the mould 200 (740). The two halves of the mould are brought together, i.e., closed, leaving a gap 226 (750) between the bonding surface of the sole placed in the lower half 210, and the bottom surface of the insole fabric of the upper, placed in the upper half 220 of the mould. The gap 226 may have a uniform thickness, or a thickness profile varying across the gap. The gap may be 2 mm to 5 mm, or larger. Bonding material, such as PU, is injected into the gap (760) for forming a bridge layer 16 that joins the upper 12 to the sole 14. For PU injection, injected PU is at a suitable temperature, such as about 63° C., or 62.6° C., to maintain required fluidity. A temperature in the range of about 55° C. to 65° C. is also suitable. For other bonding materials, the injection temperature may be different, as long as adequate fluidity may be obtained. The injected bonding material, such as injected PU, is allowed to cool down, or cure, so to solidify to form an injection-formed bonding layer (770). The formed shoe 10 is then taken out of the mould, removed from the last, appropriately trimmed and shaped (780), i.e., to complete post-injection steps to produce a finished product.

Thus, the shoe 10 shown in FIG. 6 so manufactured has its upper 12 joined by a bonding layer 16, such as PU layer, to the sole's upper 12 at its bonding surface 24, without using glue. The bonding layer 16 itself may also be used to form part of the sole structure. Additionally, the upper is lasted and disposed in the upper half of a mould during the bonding process. The shape of the manufactured shoe tends to follow that defined by the last and the hallowed space of the mould that complements the shape of the last 224. A gap 226 between insole fabric attached to the upper and upper sole, or gluing surface of sole, defines the thickness of the bonding layer 16. The bonding layer may have a flared peripheral edge 228, which protects the bottom edge 122 of the upper from being exposed (see FIG. 5). As described earlier, the flared peripheral edge 228 may form a protective belt or ring, in which case, the peripheral edge 228 has a height that is larger than that for other types of footwear. With addition of color pigments to the injection material, the peripheral edge 228 also forms a decorative belt or ring between the upper and the sole. With suitable selection of thickness of the gap 226, the bonding layer also can replace a sock liner, to provide the desired cushioning or impact attenuation. The material of injection formed bonding layer may be PU, to provide a PU injection layer. The material for upper may be selected from leather (synthetic, natural) or fabric, such as canvas, or nylon, or any other suitable material. The sole or the midsole to be bonded to upper, when PU is selected for bonding material, may be EVA or compressed EVA. The thickness of the bonding layer may be more than 5 mm, or between 2 mm and 5 mm, and may be uniform or may vary across the sole. The sole itself may have a multi-layer structure and the combination of outsole and midsole may be one of EVA/EVA, rubber/EVA, rubber/TPU/EVA, among others, so that the midsole will provide a bonding surface that bonds well with the injected PU layer.

Various embodiments of the invention have now been described in detail. Those skilled in the art will appreciate that numerous modifications, adaptations and variations may be made to the embodiments without departing from the scope of the invention, which is defined by the appended claims. The scope of the claims should be given the broadest interpretation consistent with the description as a whole and not to be limited to these embodiments set forth in the examples or detailed description thereof.

What is claimed is:

1. A method of making an article of footwear, the article of footwear having an upper and a sole, the method comprising the steps of:
placing a pre-constructed sole in a first half of a mould,
placing a pre-constructed upper in a second half of a mould, the pre-constructed upper being mounted to a last when placed in the second half,
closing the first half and the second half to bring them together, the closed mould having a gap between the sole and the last,
injecting a bonding material into the gap and allowing the injected bonding material to solidify to form an injected bonding layer to join the upper to the sole, and
removing the bonded article of footwear from the mould and the last.

2. The method of claim 1, wherein the pre-constructed sole has a multi-layer structure comprising a midsole disposed on top of and securely attached to an outsole, and wherein the midsole is made from an EVA material.

3. The method of claim 2, wherein the upper is made from a first material selected from leather, fabric and nylon, the midsole is made from an EVA material, and the bonding material is PU.

4. The method of claim 1, further comprising:
attaching an insole fabric to the upper prior to placing the pre-constructed upper in the second half of the mould,
wherein the gap is defined by a sealed space between the insole fabric and the sole when the mould is closed.

5. The method of claim 4, wherein the sealed space reduces exposure of the injected bonding material to air.

6. The method of claim 4, wherein the gap has a thickness greater than 2 mm.

7. The method of claim 4, wherein the gap has a thickness between 2 mm and 5 mm.

8. An article of footwear made from an injection process, comprising:
an upper,
a sole, the sole comprising a midsole disposed on top and securely attached to a outsole, and
a bridge layer of injected polyurethane (“PU”) material joining the midsole to the upper.

9. The article of footwear of claim 8, further comprising:
an insole fabric attached to the upper,
wherein the injected polyurethane material formed bridge layer joining the insole fabric to the midsole.

10. The article of footwear of claim 8, wherein the midsole is formed from EVA.

11. The article of footwear of claim 8, wherein the upper has a bottom edge terminating at a peripheral line joining the sole and the bridge layer has a peripheral edge, the peripheral edge being formed to have a flared protective belt to protect the bottom edge of the upper from being exposed.

12. The article of footwear of claim 11, wherein the flared protective belt extends upward along the exterior surface of the upper and has a height larger than the thickness of the bridge layer.

13. The article of footwear of claim 12, wherein the height is between 5 mm and 100 mm.

14. The article of footwear of claim 12, wherein the height is between 5 mm and 20 mm.

15. The article of footwear of claim 12, wherein the height and the thickness forms a ratio in the range between 3:1 and 20:1.

16. The article of footwear of claim 15, wherein the ratio is about 5:1.

17. The article of footwear of claim 11, wherein the flared protective belt is colored by addition of color pigments to form a decorative belt.
